(19) United States
(12) Patent Application Publication
(10) Pub. No.: US 2019/0184473 A1
(43) Pub. Date: Jun. 20, 2019

(54) METAL DRILL

(71) Applicant: Hilti Aktiengesellschaft, Schaan (LI)

(72) Inventor: Thomas FOSER, Balzers (LI)

(73) Assignee: Hilti Aktiengesellschaft, Schaan (LI)

(21) Appl. No.: 16/301,084

(22) PCT Filed: May 16, 2017
(86) PCT No.: PCT/EP2017/061646

§ 371 Date: Nov. 13, 2018

(30) Foreign Application Priority Data
May 18, 2016 (EP) 16170048.9

(51) Int. Cl. B23B 51/02; B23B 51/10

(52) U.S. Cl. CPC B23B 51/02; B23B 51/105; B23B 2251/52; B23B 2251/244; B23B 51/107

(57) ABSTRACT

A drill for drilling a blind hole having a blind hole diameter and a blind hole depth in a metal workpiece is provided, the drill comprising a shaft, defining a drilling direction, and a rotation axis oriented in the drilling direction, the shaft having, on an end pointing in the drilling direction, a cutting edge and a stop shoulder at a distance from the cutting edge which defines the blind hole depth, wherein the cutting edge defines the blind hole diameter by rotating about the rotation axis, the shaft having an enveloping circle diameter which changes along the rotation axis and which is larger than the blind hole diameter on the stop shoulder, the shaft having a first shaft section arranged between the cutting edge and the stop shoulder which reaches to the stop shoulder and in which the enveloping circle diameter is smaller than the blind hole diameter.

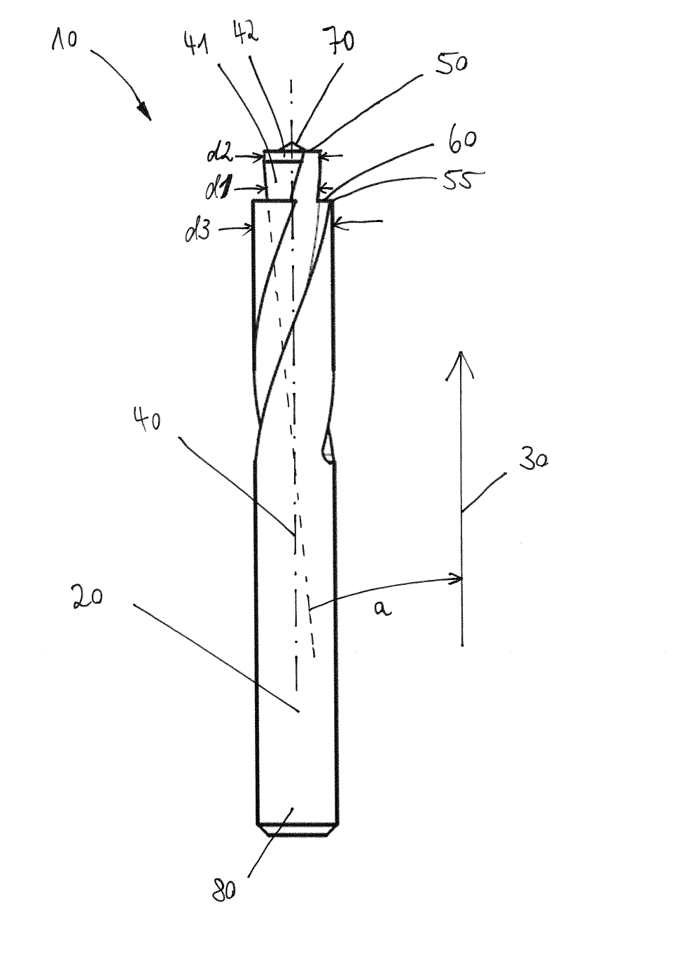

The present invention relates to a drill bit for hand-guided drilling of a blind hole into a metal workpiece.

Drill bits are known which have a shank that defines a drilling direction and has a cutting edge and a stop shoulder, the distance of which from one other defines a blind hole depth. Usually, the shank has an enveloping circle diameter between the cutting edge and the stop shoulder, which enveloping circle diameter is as large as a blind hole diameter defined by the cutting edge. In hand-guided drilling, the drill bit may be unintentionally pivoted, causing the shank to expand or damage the blind hole during drilling.

The object of the invention is to provide a drill bit which reduces the risk of widening or damaging the blind hole.

The object is achieved by a drill bit for hand-guided drilling of a blind hole, having a blind hole diameter and a blind hole depth, into a metal workpiece, the drill bit comprising a shank that defines a drilling direction and has an axis of rotation oriented in the drilling direction, the shank having a cutting edge at the end thereof facing the drilling direction and a stop shoulder at a distance from the cutting edge that defines the blind hole depth and is measured against the drilling direction, the cutting edge defining the blind hole diameter by rotation about the axis of rotation, the shank having an enveloping circle diameter which varies along the axis of rotation and which is larger at the stop shoulder than the blind hole diameter, the shank having a first shank portion which is arranged between the cutting edge and the stop shoulder and extends as far as the stop shoulder and in which the enveloping circle diameter is smaller than the blind hole diameter. Preferably, the shank has two or more cutting edges at the end thereof facing the drilling direction, which cutting edges together define the blind hole diameter by rotation about the axis of rotation and are preferably arranged symmetrically about the axis of rotation.

An enveloping circle diameter within the meaning of the invention is the diameter of the smallest possible circle which still completely envelops the shank with a circle center on the axis of rotation. In other words, for each point along the axis of rotation, the circular area of the envelope circle is the area that the shank covers when it rotates about the axis of rotation. In the case of a circular circumferential line, the enveloping circle diameter is equal to the diameter of the circumferential line, i.e. the shank diameter. Inward deviations of the circumferential line from the circular shape do not affect the enveloping circle diameter; outward deviations, however, increase the enveloping circle diameter.

In a preferred embodiment, the shank has a second shank portion arranged between the cutting edge and the first shank portion, which second shank portion extends as far as the cutting edge and in which the enveloping circle diameter is constant and equal in size to the blind hole diameter. Particularly preferably, the second shank portion extends towards the first shank portion.

In a preferred embodiment, the first shank portion extends towards the cutting edge.

In a preferred embodiment, the first shank portion and the cutting edge are made of the same material and integral with one other.

In a preferred embodiment, the enveloping circle diameter in the first shank portion increases in regions, in particular continuously, in the drilling direction. Particularly preferably, the enveloping circle diameter in the first shank portion increases linearly, thus forming a conical enveloping. The conical enveloping surface is inclined with respect to the drilling direction at a cone angle which is preferably between 2° and 10° and particularly preferably at least 5°.

In a preferred embodiment, the enveloping circle diameter in the first shank portion is constant in regions, particularly preferably continuously constant, thus forming a circular cylindrical enveloping surface.

In a preferred embodiment, the shank has, at the end thereof facing the drilling direction, a centering point through which the axis of rotation extends.

In a preferred embodiment, the stop shoulder has a stop face oriented perpendicularly to the axis of rotation and facing the drilling direction.

In a preferred embodiment, the shank has, at the end thereof facing away from the drilling direction, an attachment portion for temporary attachment to a hand-guided drill bit. Particularly preferably, the attachment portion is an insertion end.

The invention is explained in greater detail below with reference to the drawing.

The drawing is a side view of a drill bit 10, which is suitable for hand-guided drilling of a blind hole into a metal workpiece (not shown). The drill bit 10 comprises a shank 20 that defines a drilling direction 30 and has an axis of rotation 40 oriented in the drilling direction 30. At the end thereof facing the drilling direction 30, the shank 20 has a cutting edge 50 and a further cutting edge (not shown) which are arranged opposite one other and symmetrically about the axis of rotation 40 and together define a blind hole diameter of the drilled blind hole by rotation about the axis of rotation 40. In a to the cutting edge 50, the shank 20 comprises a stop shoulder 55 having a stop surface 60 that is oriented perpendicularly to the axis of rotation 40 and faces the drilling direction 30. When the blind hole is being drilled, the stop shoulder 55 strikes a surface of the workpiece, such that the distance, measured against the drilling direction 30, of the stop face 60 from the cutting edge 50 defines a blind hole depth of the drilled blind hole. At the end thereof facing away from the drilling direction 30, the shank 20 has an insertion end 80 for temporary attachment to a hand-guided drill bit.

The shank 20 has an enveloping circle diameter that varies along the axis of rotation 40. In a first shank portion 41 of the shank 40 that is arranged between the cutting edge 50 and the stop shoulder 55, the enveloping circle diameter d1 is smaller than the blind hole diameter. In a second shank portion 42 of the shank 40 that is arranged between the cutting edge 50 and the first shank portion 41, the enveloping circle diameter d2 is constant and equal in size to the blind hole diameter. At the stop shoulder 55, the enveloping circle diameter d3 is larger than the blind hole diameter. When the first shank portion 41 is directly connected to the stop shoulder 55, the second shank portion 42 is directly connected to the first shank portion 41 and to the cutting edge 50.

The enveloping circle diameter d1 in the first shank portion 41 linearly increases continuously in the drilling direction 30, such that a conical enveloping surface is formed.

The conical enveloping surface is inclined with respect to the drilling direction 30 by a cone angle a of 5°. The enveloping circle diameter d2 in the second shank portion 42 is continuously constant, such that a circular cylindrical enveloping surface is formed which protects the cutting edge 50 from excessive wear if necessary.

Furthermore, the shank 20 has a centering point 70 at the end thereof facing the drilling direction 30, through which centering point the axis of rotation 40 extends. The entire shank 40, including the cutting edge 50 and the centering point 70, is formed in one piece, so that the stop shoulder 55, the first shank portion 41, the second shank portion 42 and the cutting edge 50 are made of the same material, preferably a metal or an alloy, particularly preferably a steel.

In order to remove metal shavings produced during drilling from the cutting edge 50 and the further cutting edge, the shank 20 has two helical grooves 90 which extend through the stop shoulder 55, the first shank portion 41 and the second shank portion 42 and are delimited by the cutting edge 50 and the further cutting edge, respectively.

The invention has been described with reference to the example of a metal drill bit. However, it should be noted that the drill bit according to the invention is also suitable for other purposes.

1. A drill bit for drilling a blind hole having a blind hole diameter and a blind hole depth, into a metal workpiece, the drill bit comprising a shank that defines a drilling direction and has an axis of rotation oriented in the drilling direction, the shank having a cutting edge at an end thereof facing the drilling direction and a stop shoulder at a distance from the cutting edge that defines the blind hole depth and is measured against the drilling direction, the cutting edge defining the blind hole diameter by rotation about the axis of rotation, the shank having an enveloping circle diameter which varies along the axis of rotation and which is larger at the stop shoulder than the blind hole diameter, the shank having a first shank portion which is arranged between the cutting edge and the stop shoulder and extends as far as the stop shoulder and in which the enveloping circle diameter is smaller than the blind hole diameter.

2. The drill bit according to claim 1, wherein the shank has a second shank portion arranged between the cutting edge and the first shank portion, the second shank portion extending as far as the cutting edge and in which the enveloping circle diameter is constant and equal in size to the blind hole diameter.

3. The drill bit according to claim 2, wherein the second shank portion extends towards the first shank portion.

4. The drill bit according to claim 1, wherein the first shank portion extends towards the cutting edge.

5. The drill bit according to claim 1, wherein the first shank portion and the cutting edge are made of the same material and are integral with one other.

6. The drill bit according to claim 1, wherein the enveloping circle diameter in the first shank portion increases in regions in the drilling direction.

7. The drill bit according to claim 1, wherein the enveloping circle diameter in the first shank portion is constant in regions.

8. The drill bit according to claim 1, wherein the shank has, at the end thereof facing the drilling direction, a center point through which the axis of rotation extends.

9. The drill bit according claim 1, wherein the stop shoulder has a stop face oriented perpendicularly to the axis of rotation and facing the drilling direction.

10. The drill bit according to claim 1, wherein the shank has, at an end thereof facing away from the drilling direction, an attachment portion for temporary attachment to the drill bit.

11. The drill bit according to claim 6, wherein the enveloping circle diameter in the first shank portion increases in regions continuously.

12. The drill bit according to claim 11, wherein the enveloping circle diameter in the first shank portion increases in regions linearly.

13. The drill bit according to claim 7, wherein the enveloping circle diameter in the first shank portion is constant in regions continuously.

14. The drill bit according to claim 2, wherein the first shank portion and the cutting edge are made of the same material and are integral with one other.

15. The drill bit according to claim 3, wherein the first shank portion and the cutting edge are made of the same material and are integral with one other.

16. The drill bit according to claim 4, wherein the first shank portion and the cutting edge are made of the same material and are integral with one other.

17. The drill bit according to claim 2, wherein the enveloping circle diameter in the first shank portion increases in regions in the drilling direction.

18. The drill bit according to claim 3, wherein the enveloping circle diameter in the first shank portion increases in regions in the drilling direction.

19. The drill bit according to claim 4, wherein the enveloping circle diameter in the first shank portion increases in regions in the drilling direction.

20. The drill bit according to claim 5, wherein the enveloping circle diameter in the first shank portion increases in regions in the drilling direction.
